(19) United States
(12) Patent Application Publication
(10) Pub. No.: US 2015/0178697 A1
(43) Pub. Date: Jun. 25, 2015

(54) Operating a Self Service Terminal as a Virtual Teller

(71) Applicants: Wolf-Dieter Rossmann, Angus (GB); John Hall, Angus (GB)

(72) Inventors: Wolf-Dieter Rossmann, Angus (GB); John Hall, Angus (GB)

(73) Assignee: NCR Corporation, Duluth, GA (US)

(21) Appl. No.: 14/135,746

(22) Filed: Dec. 20, 2013

(51) Int. Cl. G06Q 20/10; G07F 19/00

(52) U.S. Cl. CPC G06Q 20/1085; G07F 19/211

(57) ABSTRACT

Approaches are disclosed for operating a self service terminal, such as an automatic teller machine, as a virtual teller in a branch office. A virtual teller terminal is connected to a secure banking network at a bank branch office and a virtual teller account is established between the automatic teller machine and a branch server operating the branch office. The virtual teller account is used by the automatic teller machine to process customer requests received by the automatic teller machine.

### FIELD OF THE INVENTION

The present invention relates to a method and computer based apparatus for operating a self service terminal in a banking environment. In particular, but not exclusively, the present invention relates to using an established banking infrastructure that supports bank teller functions to operate a self service terminal as a virtual teller.

### BACKGROUND

Banks have well established computer infrastructures that support and protect the assets and operations of the banks. The computer infrastructure provides computer and network support for bank branch offices where human tellers provide services to customers that visit branch offices. The services provided to customers include depositing currency and checks, cashing a check, withdrawing currency and checking customer account balances, to name a few. To provide these services, the bank provides a computer terminal (teller terminal) connected to the bank's computer infrastructure. In addition, bank branches may suitably include one or more self service terminals (SST) such as Automated Teller Machines (ATM). For ATMs, the bank provides a separate network connection and computer support using an ATM host/switch. This requires the bank's infrastructure to support two different types of networks and two different sets of business logic, one for ATMs and one for teller operations. This duplication adds complexity and cost to the infrastructure plus the business logic typically places lower transaction limits on functions performed by an ATM.

### SUMMARY

Among its several aspects, the present invention seeks to overcome or ameliorate at least one of the disadvantages of the prior art, or to provide a useful alternative.

Among its several aspects, the present invention recognizes that there is an advantage to allowing a self service terminal to use the business logic defined for human tellers where a supervisor or manager can approve transactions that are above a predefined limit for the self service terminal.

The invention further recognizes the advantages of interfacing self service terminals to the business logic defined for tellers without having to modify the business logic to operate self service terminals and to retain the safeguards provided by a human teller.

The invention additionally recognizes the benefits to customers using a self service terminal managed by teller business logic because predetermined transaction limits for the self service terminal can be over ridden by a human teller or a human supervisor.

The invention recognizes the advantages of creating a virtual teller terminal on a bank's network by having a server computer on the bank's network emulate a teller terminal. The virtual teller terminal communicates with a self service terminal and a branch server that controls teller terminals located at a bank branch office. To the branch server, the virtual teller terminal appears to be a real teller terminal located at the branch office. To the self service terminal, the virtual teller terminal appears to be a type of ATM host/switch that controls the operation of the self service terminal. This approach results in minimal changes to the branch server, the business logic implemented by the branch server and the self service terminal. The changes that are required include setting up network device accounts for each of the virtual teller terminals and teller accounts for each of the self service terminals that will use the virtual teller terminal to communicate with the branch server.

In accordance with an embodiment of the present invention, a method of operating a computer server is provided to emulate a virtual teller terminal and allow a self service terminal to use the virtual teller terminal to create a virtual teller. The method is implemented by one or more processors of a server that executes processor instructions stored in a non-transitory processor readable medium. The method comprises the steps of: receiving a command from a self service terminal; translating the received command into a teller terminal command; transmitting the translated command to a branch server for processing as a teller entered command; receiving a reply from the branch server in response to the translated command; translating the received reply from a teller reply to a command reply to the command from the self service terminal; and transmitting the command reply to the self service terminal.

In accordance with an embodiment of the present invention, there is provided a computer server that emulates a teller terminal on a bank branch office network. The computer server comprises: a memory including a non-transitory processor readable medium wherein processor instructions and data are stored; and a processor in communication with the memory where when the processor executes the processor instructions, the processor instructions cause the processor to perform the following steps: receiving a command from a self service terminal; translating the received command into a teller terminal command; transmitting the translated command to a branch server for processing as a teller-entered command; receiving a reply from the branch server in response to the translated command; translating the received reply from a teller reply to a command reply to the command from the self service terminal; and transmitting the command reply to the self service terminal.

In accordance with an embodiment of the present invention, a method of interconnecting a self-service terminal and a branch server. The method is implemented by one or more processors of a server that executes processor instructions stored in a non-transitory processor readable medium. The method comprising: instantiating a virtual branch terminal; providing a self-service terminal host interface between the self-service terminal and the virtual branch terminal and a branch terminal interface between the virtual branch terminal and the branch server; associating the self-service terminal with the virtual branch terminal; assigning a virtual teller identity to the self-service terminal so that communications from the self-service terminal appear to originate from the virtual teller identity; converting communications received via the self-service terminal host interface to communications corresponding to the branch terminal interface; and transmitting the converted communications to the branch server.

A more complete understanding of the present invention, as well as further features and advantages of the invention, will be apparent from the following Detailed Description and the accompanying Drawings.

### BRIEF DESCRIPTION OF THE DRAWINGS

The present invention may take form in various components and arrangement of components and in various methods. The drawings are for purposes of illustrating example embodiments and alternatives and are not to be construed as limiting the invention. The drawings are not necessarily drawn to scale. Throughout the drawings, like element numbers are used to describe the same parts throughout the various drawings, figures and charts.

FIG. 1 is a high-level drawing illustrating an exemplar embodiment of a banking system of the present invention.

FIG. 2 is a high-level block diagram illustrating selected components of a branch communication server in accordance with an exemplar embodiment of the present invention.

FIG. 3 is a high-level flow diagram illustrating a method of operating the branch communication server of FIG. 2.

FIG. 4 is a high-level flow diagram illustrating another method of operating the branch communication server of FIG. 2.

### DETAILED DESCRIPTION

In the following description, numerous details are set forth to provide an understanding of the claimed invention. However, it will be understood by those skilled in the art that aspects of the claimed invention may be practiced without utilizing all of these details and that numerous variations or modifications from the described embodiments are possible and envisioned.

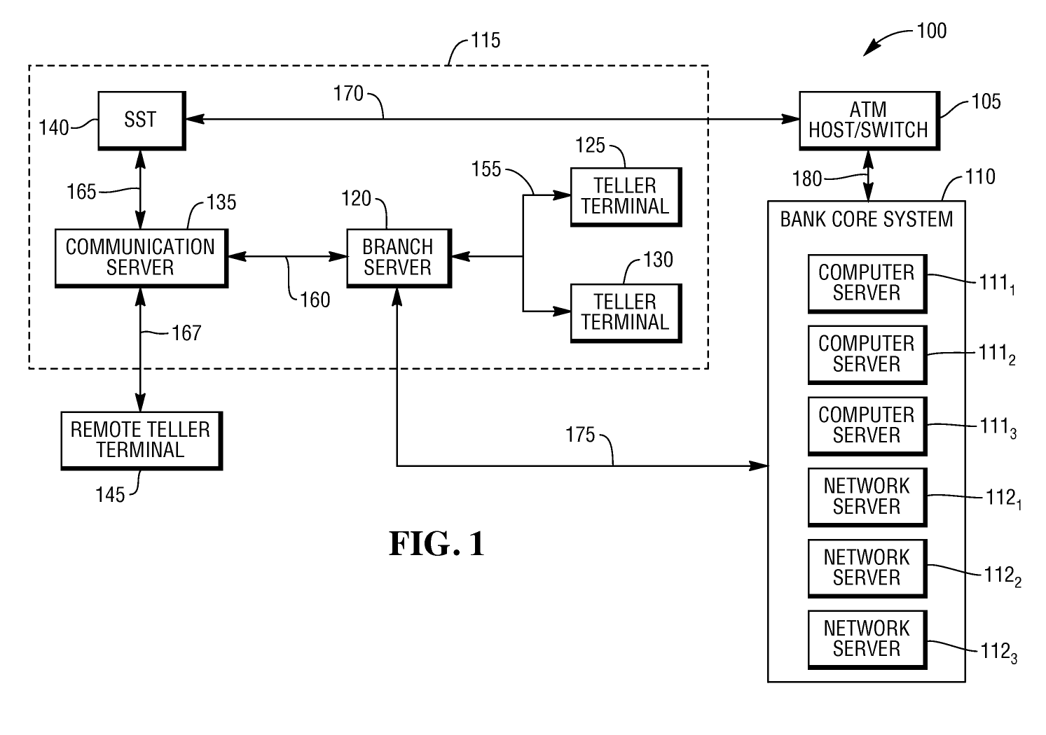

Reference is first made to FIG. 1, which is a high-level drawing illustrating an exemplar embodiment of a banking system 100. The banking system 100 is operated by a bank and includes a bank core system 110 which may suitably include multiple computer servers 111₁, 111₂, 111₃ and multiple network servers 112₁, 112₂, 112₃. One or more of the computer servers implement one or more databases that store and manage bank related information including customer account data. The network servers support multiple networks that connect the multiple computer servers with each other and with other servers and equipment that are remotely located in the banking system 100 and with networks and computers that are outside of the banking system 100.

The banking system 100 further includes a bank branch office 115 which is suitably a physical structure where employees of the bank provide financial services to bank customers that are present at the branch office 115. While not shown, the bank system 100 may suitably include multiple branch offices. The branch office 115 houses multiple teller terminals (branch terminal) represented by a first teller terminal 125 and a second teller terminal 130. These terminals 125, 130 are used by human tellers who are bank employees and perform customer transactions for customers present at one of the teller terminals 125, 130. The teller terminals 125, 130 are connected over a first computer network 155 to a branch server 120 which controls the terminals 125, 130 and processes the requested customer transactions.

A human teller may suitably login to either of the teller terminals 125, 130 using an ID and password that uniquely identifies the teller. Once the human teller has been authenticated, the teller may perform customer related transactions for a customer at the bank branch 115. As each teller performs a login function, the branch server 120 may authenticate the teller or may delegate the function to a remote authentication system to authenticate the teller. The branch server 120 also includes information about the role, authorizations and limits of each teller. For example, a teller may be a supervisor with authority to approve certain transactions that a normal teller cannot perform without a supervisor's approval. When a normal teller attempts to perform a customer transaction that violates predetermined limits, the branch server 120 will stop the transaction until a supervisor has approved the transaction. In some cases, the branch server 120 will notify the supervisor. The branch server 120 further connects over a second computer network 175 to the bank core system 110 which may suitably be located remotely from the branch office 115.

The bank core system 110 communicates over a third computer network 180 to an ATM host/switch 105. The ATM host/switch 105 communicates with a plurality of self service terminals operating in many different locations. Some of the self service terminals may be owned and operated by the bank that operates the banking system 100 and other self service terminals may be owned by other banks or businesses and contract with the bank to provide banking transactions through the banking system 100. The ATM host/switch 105 communicates over a fourth computer network 170 to a self service terminal 140. In this embodiment, the self service terminal 140 is an automatic teller machine (ATM) 140.

The ATM 140 is controlled by a control application executed by a processor within the ATM 140. The control application may suitably communicate with an external server, such as the ATM host/switch 105, to conduct customer transactions. Customer transactions performed by the ATM 140 are subject to certain transaction limits that are predetermined for the ATM 140. If a customer requests a transaction such as a cash withdrawal that exceeds the predetermined limits of the ATM 140, the ATM host/switch 105 will deny the transaction prior to any further processing of the request.

The ATM host/switch 105 may communicate with the ATM 140 using a defined message protocol. The defined message protocol may be an industry-standard message interface, such as IFX (Interactive Financial eXchange), ISO 8583, or the like; or a proprietary message interface, such as the NCR Direct Connect (NDC) message interface (from NCR Corporation™), the 91x message interface provided by Diebold, Inc.™, or the like.

The banking system 100 further includes a branch communication server 135 that communicates with the branch server 120 over a fifth computer network 160, with the ATM 140 over a sixth computer network 165 and with a remote teller terminal 145 over a seventh computer network 167. In some embodiments, the remote teller terminal is located within the branch office 115. An example of the branch communication server 135 is the NCR Orchestration Server product developed by NCR Corporation. The branch communication server 135 is located within the bank branch 115. In some embodiments, the branch communication server 135 is not physically located within the branch office 115 but instead is located in a remote data center. The data center provides communications to the branch office 115 that allows the branch communication server 135 to communicate as if it were physically located within the branch office 115. The branch communication server 135 may suitably include one or more computer servers that together perform the functions of the branch communication server 135 which include providing authorizations and overrides for transactions.

The remote teller terminal 145 may suitably be located in a call center and operated by a person trained to answer banking questions for the bank and in some cases to approve certain customer transactions. The branch communication server 135 provides information about the customer and the transaction being performed. In addition, a video link may be established between the remote teller terminal 145 and the ATM 140 by the branch communication server 135. This allows the customer of the ATM 140 to see, hear and interact with the customer service person or a human teller operating the remote teller terminal 145. In some embodiments, the remote teller terminal 145 is located within the branch office 115 and is operated by a human teller. When a customer request at the ATM 140 violates certain predetermined transaction limits, a request is generated for a human teller or a supervisor to provide assistance to the customer. In some cases, a video link with the remote teller terminal 145 is initiated to help the customer. In other embodiments, a local teller may initiate a video link from one of the teller terminals 125, 130, 145 to the ATM 140 using the branch communication server 135 to communicate with the customer and resolve the issue.

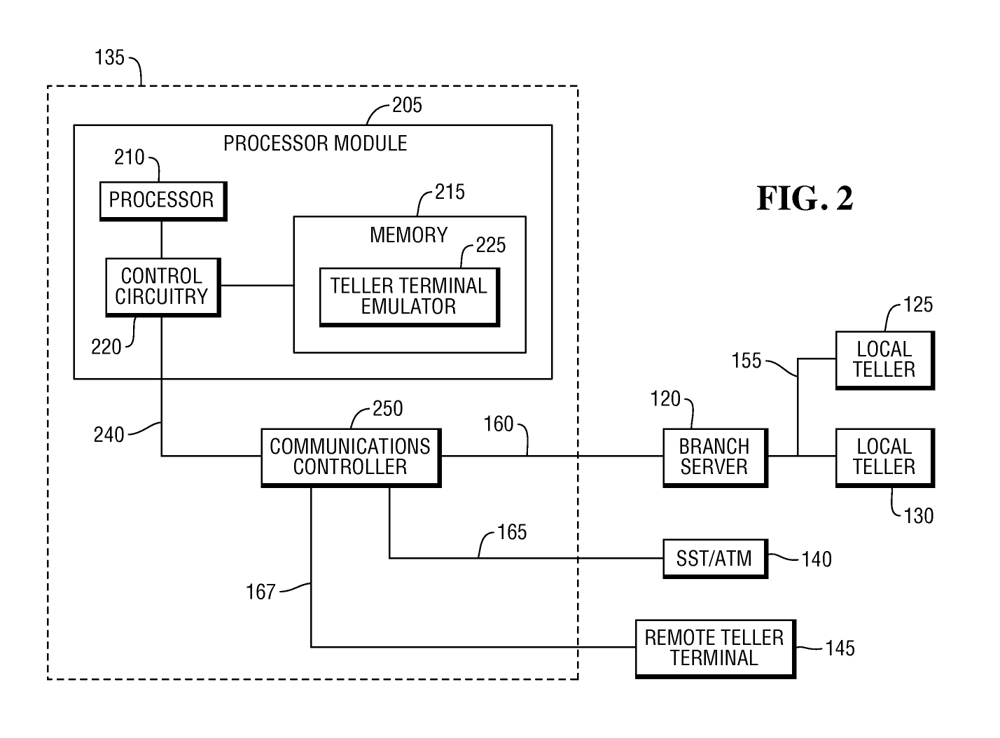

Turning now to FIG. 2, there is provided a high-level drawing illustrating an exemplar embodiment of the branch communication server 135. The branch communication server 135 includes a processor module 205 that includes a processor 210, a memory 215, and control circuitry 220. The processor 210 may suitably be implemented using multiple processors and each processor may suitably include multiple processor cores. The multiple processors may further be implemented across multiple computers that are networked together and act in concert. The memory 215 is non-transitory and processor readable. The memory 215 includes both volatile and non-volatile memory. The non-volatile memory may suitably include solid state and/or rotating memory devices.

The processor 210 executes computer instructions stored in the memory 215 which when executed by the processor 210 cause the processor 210 to control the components of the branch communication server 135 and to implement the features and functions of the branch communication server 135. The control circuitry 220 includes hardware that provides the interfaces between the processor 210 and the memory 215 and between the processor 210 and a bus 240 used to communicate with other components of the branch communication server 135. The communications controller 250 includes the hardware and software required for the branch communication server 135 to connect to and communicate over the external networks 160, 165, 167. In some embodiments, two or more of the external networks 160, 165, 167 are combined into one network.

Processor instructions and computer data are organized as computer programs and stored within the memory 215. One computer program stored within the memory 215 is a teller terminal emulator 225. When the teller terminal emulator 225 is executed by the processor 210, it communicates with the branch server 120 and creates one or more virtual teller terminals on the network that appear to the branch server 120 as real teller terminals. In addition, the teller terminal emulator 225 creates one or more virtual tellers that use the virtual teller terminals to communicate with the branch server 120. The teller terminal emulator 225 also communicates with the ATM 140 and provides an interface that allows the ATM 140 to use the virtual teller terminals to communicate with the branch server 120 as a virtual teller.

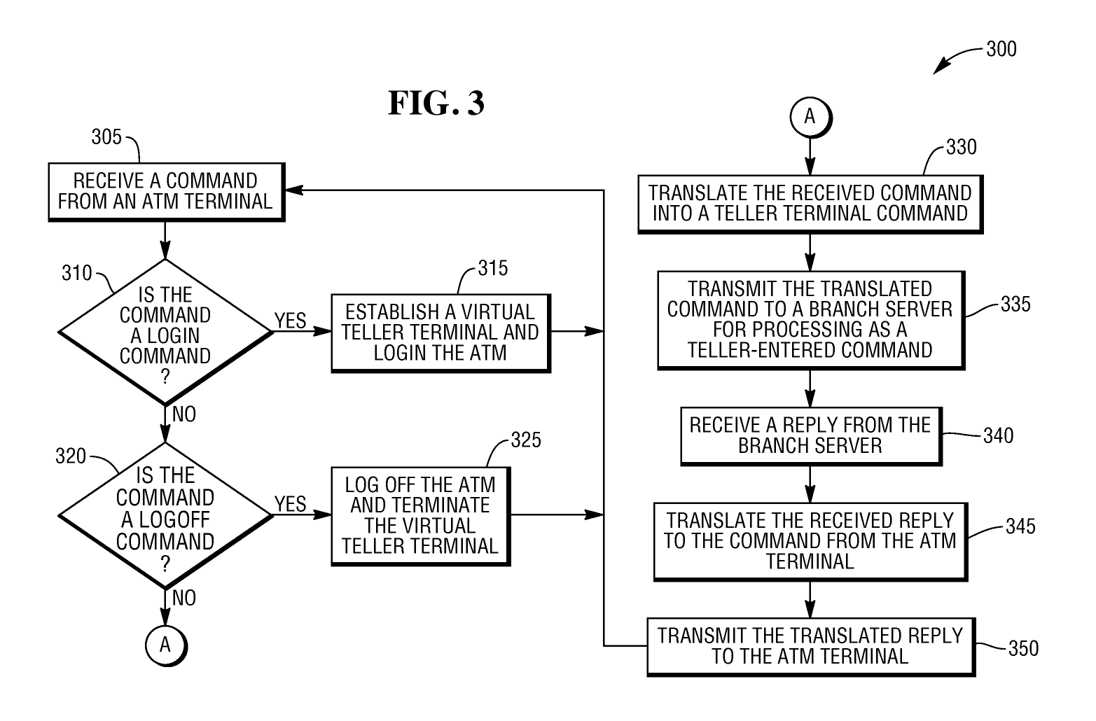

With reference to FIG. 3, there is presented a high-level flow diagram illustrating a method 300 of operating the branch communication server 135 and more specifically a method of executing the teller terminal emulator 225. The following method 300 describes one embodiment of the branch communication server 135 and one method of emulating a teller terminal. The method 300 is implemented by the processor 210 when the processor 210 executes the teller terminal emulator software 225 stored in the memory 215.

The teller terminal emulator 225 communicates with the branch server 120 and the ATM 140. To the branch server 120, the teller terminal emulator 225 appears as a virtual teller terminal by generating a network presence and interface that to the branch server 120 is identical to a real teller terminal. The virtual teller terminal's network presence is generated by dynamically setting up and registering an Internet Protocol (IP) address on the fifth computer network 160 and setting up the communication server 135 to host the IP address and to service all network requests made to the IP address. The communication server 135 routes all network requests made to the IP address to the teller terminal emulator 225 which processes the requests to emulate a teller terminal. The teller terminal emulator 225 can generate a plurality of virtual teller terminals by setting up additional IP addresses. The branch server 120 sees each IP address as a teller terminal. To the ATM 140, the teller terminal emulator 225 provides an interface compatible with the ATM host/switch 105. In this embodiment, the interface exposed to the ATM 140 appears to be a second ATM host/switch. In other embodiments, the interface exposed to the ATM 140 may be a unique interface that exposes features and functions available to the teller terminal but not to the ATM host/switch 105. In other embodiments, the virtual teller terminal is attached to or made known to the computer network 160 using a different communication protocol.

The teller terminal emulator 225 creates a communication session between the ATM 140 and a created virtual teller terminal that is associated with the branch server 120. The teller terminal emulator 225 translates data received from the ATM 140 in ATM host/switch 105 format into a format used by a teller terminal and transmits the data to the branch server 120 using the virtual teller terminal interface. The ATM 140 uses the communication session to send and receive commands and data with the branch server 120 through the virtual terminal interface. The ATM 140 does not have to implement the teller terminal interface or the interface with the branch server 120 because the teller terminal emulator 225 provides this function. Having the teller terminal emulator 225 provide these functions simplifies the software on the ATM 140.

In this embodiment, the communication server 135 receives data transmitted to the virtual teller terminal by the branch server 120 and delivers the data to the teller terminal emulator 225 for processing. The received data is then translated from teller terminal format into ATM host/switch 105 format and transmitted to the ATM 140. Typically this involves changing header information and the field structure in data packets and mapping codes from one format to the other format. In some embodiments, the received data is translated from terminal format into a data format suitable to interface ATM software executing on the ATM 140 which is not the same as the ATM host/switch 105 format.

In step 305, the processor 210 receives a command from the ATM 140 that is to be translated into a teller terminal command and sent to the branch server 120 for processing. For example, the command may comprise a cash withdrawal with customer identification data or a command to login to the virtual teller terminal or a command to logoff the virtual teller terminal, to name a few. The ATM command is received over the sixth computer network 165 which connects the communications server 135 to the ATM 140.

In step 310, the processor 210 determines if the received ATM command is a login command. The login command is a command that would normally be used by a human teller to login to the branch server 120 from one of the teller terminals 125, 130. When a human teller logs in to the branch server 120, the human teller must provide an ID that identifies the teller and a password to authenticate the teller. The branch server 120 uses the information to determine what access to information, what privileges and what predefined limits on transactions the teller should have. Once logged in, the human teller can perform transactions for a customer. If the command is a login command, control passes to step 315, otherwise control passes to step 320.

In some embodiments, the communication server 135 will automatically perform the login and logoff function to the branch server 120 when the ATM 140 establishes the communication session with the communication server 135. The ATM 140 does not have to maintain IDs and passwords for the branch server 120.

In step 315, the processor 210 establishes a virtual teller terminal on the network 160 to communicate with the branch server 120. Depending on the type of communications network being used, the processor 210 may be required to enroll a virtual teller terminal with the network. This can be accomplished by using trusted certificates that are recognized by the network 160 and accepted as authorization to join the network 160 and to have certain access privileges and trust relationships. Trusted certificates are provided by trusted third parties. In some embodiment, the processor 210 will use an alternate approach and directly join the virtual teller terminal to the network 160 using a network ID and password that is authorized to join computers to the network 160.

Once the virtual teller terminal is established, the processor 210 creates a communication session and binds the ATM 140 to the virtual teller terminal so that the ATM 140 can send and receive commands and data with the branch server 120 over the virtual teller terminal. The ATM 140 only sees the interface to the communication session. The processor 210 translates the data received from the ATM 140 so that to the branch server 120 it is data that would be normally received from a teller terminal but it is received from the virtual teller terminal. After the virtual teller terminal is established on the network 160 and the communication session is created, the processor 210 sends data to the branch server 120 that implements a standard human teller login function to create an active virtual teller. The information to login as a virtual teller is stored in the communication server 135 and associated with the ATM 140. Control then passes back to step 305.

In step 320, the processor 210 has determined that the command is not a login command. The processor 210 then determines if the command is a logoff command. A logoff command is used by a human teller to logoff the branch server 120 from one of the teller terminals 125, 130. The ATM 140 can use the logoff command to logoff the virtual teller. If the command is a logoff command, control passes to step 325, otherwise control passes to step 330.

In step 325, the processor 210 sends a logoff command to the branch server 120 over the virtual teller terminal for the virtual teller. After the branch server 120 acknowledges the logoff, the processor 210 removes the virtual teller terminal from the network 160 and sends status information to the ATM 140 indicating these actions. The communication session with the ATM 140 is then terminated. Control then passes to step 305.

In step 330, the processor 210 translates the command received from the ATM 140 into the format used by the teller terminals 125, 130. The interface to a teller terminal involves interacting with a human teller. To conduct a function, multiple screens may need to be displayed and multiple responses generated by the teller terminal. For example, a human teller may request a command by selecting a button on a display. A second screen is generated that might request customer information which the teller would input. A third screen might request additional information about the request. The processor 210 has to emulate each of the actions that would occur on a real teller terminal with a human teller. This is part of what is meant by translating a command into the format used by the teller terminals 125, 130.

In step 335, the processor 210 transmits the translated command to the branch server 120 for processing. The translated command is transmitted to the branch server 120 so that to the branch server 120, the translated command appears to have been received from a human teller logged into an actual teller terminal at the branch office 115. The branch server 120 then processes the received translated command.

In step 340, the processor 210 receives a reply from the branch server 120 in response to processing the received translated command. The reply is received by the processor 210 over the previously established virtual teller terminal connection. Since the virtual teller terminal is assigned to the ATM 140, the processor 210 determines that the reply is to be returned to the ATM 140.

In step 345, the processor 210 translates the received reply into a format used by the ATM 140. This format may suitably be the same as or similar to the format used to communicate with the ATM host/switch 105.

In step 350, the processor 210 transmits the translated reply to the ATM 140.

It should be noted that the ATM 140 may suitably maintain active communications with both the branch server 120 and the ATM host/switch 105 at the same time. However, the ATM 140 will process a customer transaction through either the branch server 120 or the ATM host/switch 105, but not both. The ATM 140 may select to use the branch server 120 instead of the ATM host/switch 105 for several reasons. If the customer using the ATM 140 is a customer of the same bank that owns the ATM 140 and branch server 120, using the branch server 120 may avoid charges imposed by the operator of the ATM host/switch 105 or a downstream operator. If the customer using the ATM 140 is not a customer of the same bank that owns the ATM 140, the customer request is routed through the ATM host/switch 105 which will route the request to the customer's bank.

The ATM 140, in common with most or all conventional ATMs, has predetermined limits on transactions such as cash withdrawals. Human tellers also have predetermined limits on transactions based on their training, level of experience and job function. When a human teller tries to perform a transaction that is over a predetermined limit, a supervisor is notified and the supervisor may either approve or deny the transaction. For example, an entry level human teller may have a predetermined limit of $1000 per cash withdrawal. If a customer requests to withdraw more than $1000, the withdrawal must first be approved by a supervisor. The ATM 140 has a predetermined limit of $500 per cash withdrawal. However, when the ATM 140 uses the branch server 120 to process a cash withdrawal, a supervisor may override the predetermined limit and allow the ATM 140 to dispense the cash.

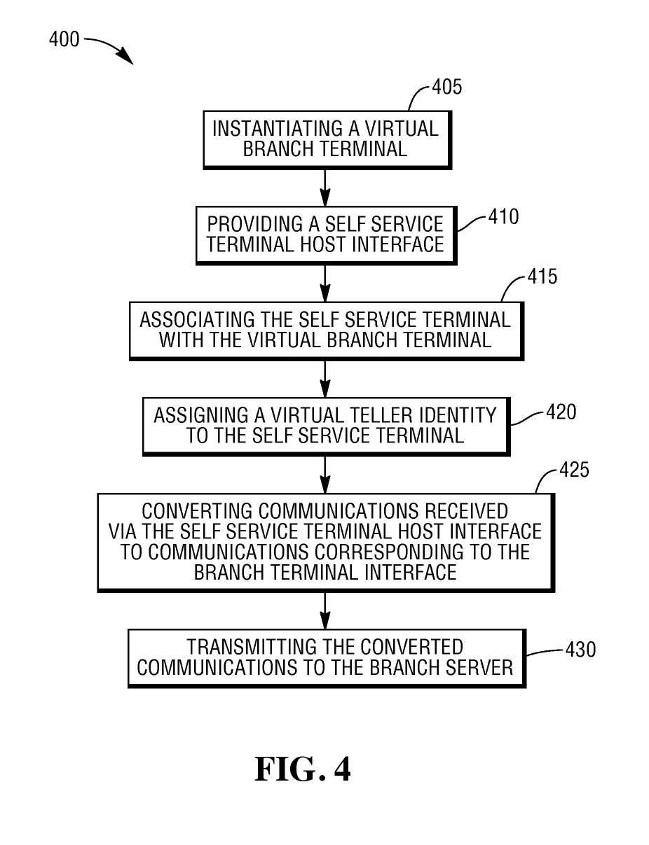

Turning now to FIG. 4, there is presented a high-level flow diagram illustrating a method 400 of operating the branch communication server 135. The following method 400 describes an embodiment of the branch communication server 135 and another method of operating it. The method 400 is implemented by the processor 210 when the processor 210 executes the processor instructions stored in the memory 215.

In step 405, the processor 210 instantiates a virtual branch terminal. The virtual branch terminal emulates one of the teller terminals 125, 130. To the branch server 120, the virtual branch terminal appears to be a real teller terminal. The communications server 120 supports multiple virtual branch terminals which can be created as needed and destroyed when no longer needed.

In step 410, the processor 210 provides a self service terminal host interface between the self service terminal 140 and the virtual branch terminal and a branch terminal interface between the virtual branch terminal and the branch server 120.

In step 415, the processor 210 associates the self service terminal 140 with the virtual branch terminal. This provides a method of mapping communications between multiple self service terminals and multiple virtual branch terminals.

In step 420, the processor 210 assigns a virtual teller identity to the self service terminal so that communications from the self service terminal 140 appear to originate from the virtual teller identity. The virtual teller identity has predetermined transaction limits and privileges associated with it.

In step 425, the processor 210 converts communications received via the self service terminal host interface to communications corresponding to the branch terminal interface. The conversion between the two interfaces involves changing header information and the field structure in data packets and mapping codes from one interface to the other interface.

In step 430, the processor 210 transmits the converted communications to the branch server 120. The branch server 120 then processes the communications as if it were received from one of the teller terminals 125, 130.

Although the present invention has been described with particular reference to certain preferred embodiments thereof, variations and modifications of the present invention can be effected within the spirit and scope of the following claims.

What is claimed is:

1. A processor implemented method for emulating a teller terminal programmed in a non-transitory processor readable medium and to execute on one or more processors of a server configured to execute the method, the method comprising the steps of:
receiving a command from a self service terminal;
translating the received command into a teller terminal command;
transmitting the translated command to a branch server for processing as a teller-entered command;
receiving a reply from the branch server in response to the translated command;
translating the received reply from a teller terminal reply to a command reply to the command from the self service terminal; and
transmitting the command reply to the self service terminal.

2. The method of claim 1, wherein the command is a request to login to the branch server as a virtual teller.

3. The method of claim 2 further comprising:
connecting a virtual teller terminal to a bank network using a trust certificate; and
logging in as a virtual teller to the branch server from the virtual teller terminal.

4. The method of claim 1, wherein the command is a request to withdraw money from a customer account and dispense the money to the customer.

5. The method of claim 4, wherein the amount of money requested to be dispensed exceeds the predetermined limits of the self service terminal and wherein the reply from the branch server includes a response from a human supervisor teller either approving or denying the request to dispense the money.

6. The method of claim 1, wherein the self service terminal is an automated teller machine.

7. The method of claim 1, further comprising:
establishing a real-time video link between the self service terminal and a remote teller terminal.

8. The method of claim 7, wherein the real-time video link is established in response to transmitting the translated command to the branch server.

9. The method of claim 1, wherein the transmitted translated command has the same format as a command transmitted from a human teller terminal connected to the branch server.

10. The method of claim 1, wherein the received reply from the branch server has the same format as a reply transmitted to a human teller terminal connected to the branch server.

11. A computer server comprising:
a memory including a non-transitory processor readable medium wherein processor instructions and data are stored; and
a processor in communication with the memory where when the processor executes the processor instructions, the processor instructions cause the processor to perform the following steps:
receiving a command from a self service terminal;
translating the received command into a teller terminal command;
transmitting the translated command to a branch server for processing as a teller-entered command;
receiving a reply from the branch server in response to the translated command;
translating the received reply from a teller terminal reply to a command reply to the command from the self service terminal; and
transmitting the command reply to the self service terminal.

12. The computer server of claim 11, further comprising:
a first computer network connected to the self service terminal;
a second computer network connected to the bank branch computer server; and
where the processor is in communication with the first and second network.

13. The computer server of claim 11, wherein when the received command is a request to login to the branch server and the processor further performs the steps of:
connecting a virtual teller terminal to a bank network using a trust certificate; and
logging in as a virtual teller to the branch server from the virtual teller terminal.

14. The computer server of claim 13, wherein when the received command is a request to logoff the branch server and the processor further performs the steps of:
logging off the virtual teller from the branch server using the virtual teller terminal; and
removing the virtual teller terminal from the bank network.

15. The computer server of claim 11, wherein the received command is a request to withdraw money from a customer account and dispense the money to the customer.

16. The computer server of claim 15, wherein the amount of money requested to be dispensed exceeds the predetermined limits of the self service terminal and wherein the reply from the branch server includes a response from a human supervisor teller either approving or denying the request to dispense the money.

17. The computer server of claim 11, wherein the self service terminal is an automated teller machine.

18. The computer server of claim 11, wherein the processor further performs the steps of:
establishing a real-time video link between the self service terminal and a remote teller terminal.

19. A method of interconnecting a self service terminal and a branch server, the method comprising:
instantiating a virtual branch terminal;
providing a self service terminal host interface between the self service terminal and the virtual branch terminal and a branch terminal interface between the virtual branch terminal and the branch server;
associating the self service terminal with the virtual branch terminal;
assigning a virtual teller identity to the self service terminal so that communications from the self service terminal appear to originate from the virtual teller identity;
converting communications received via the self service terminal host interface to communications corresponding to the branch terminal interface; and
transmitting the converted communications to the branch server.

20. A method according to claim 19, wherein the method comprises the further steps of:
associating the virtual branch terminal with a self service terminal host;
converting communications received via the branch terminal interface to self service terminal communications corresponding to the self service terminal host interface; and
transmitting the converted self-service terminal communications to the self service terminal.
